(19) United States
(12) Patent Application Publication
(10) Pub. No.: US 2022/0134143 A1
(43) Pub. Date: May 5, 2022

(54) Interchangeable Filter Facemask Apparatus

(71) Applicant: Jimmie James, Kansas City, MO (US)

(72) Inventor: Jimmie James, Kansas City, MO (US)

(21) Appl. No.: 17/089,001

(22) Filed: Nov. 4, 2020

(51) Int. Cl. A62B 23/02; A41D 13/11

(52) U.S. Cl. CPC A62B 23/025; A41D 13/1161

(57) ABSTRACT

An interchangeable filter facemask apparatus for providing a variety of different filtration options includes a mask body including a body perimeter portion, a sidewall extending from the body perimeter portion, a body left side, a body right side, a body nose side, a body chin side, a body outside, and a body inside. The sidewall has a filter aperture extending from the body outside through the body inside. A headband is coupled to the mask body. A body engagement member is coupled to the body outside adjacent an aperture perimeter of the filter aperture. Each of a plurality of filters has a filter outside, a filter inside, and a filter perimeter. Each filter has a filter engagement member coupled to the filter inside adjacent the filter perimeter. The filter engagement member is selectively engageable with the body engagement member to cover the filter aperture with the filter.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to protective breathing devices and more particularly pertains to a new protective breathing device for providing a variety of different filtration options.

### (2) Description of Related Art Including Information Disclosed Under 37 CFR 1.97 and 1.98

The prior art relates to protective breathing devices. Known devices have a variety of different filter attachments. These devices typically involve some type of mechanical engagement mechanism in conjunction with a soft filter. Such devices also do not have a fully removable front section to allow for open air breathing or breathing with only a mesh filter when desired.

### BRIEF SUMMARY OF THE INVENTION

An embodiment of the disclosure meets the needs presented above by generally comprising a mask body including a body perimeter portion configured to encompass a user's mouth and nose, a sidewall extending from the body perimeter portion, a body left side, a body right side, a body nose side, a body chin side, a body outside, and a body inside. The sidewall has a filter aperture extending from the body outside through the body inside. A headband is coupled to the mask body. The headband is coupled to the body perimeter portion and extends from the body left side to the body right side. A body engagement member is coupled to the mask body. The body engagement member is coupled to the body outside adjacent an aperture perimeter of the filter aperture. Each of a plurality of filters has a filter outside, a filter inside, and a filter perimeter. Each filter has a filter engagement member coupled to the filter inside adjacent the filter perimeter. The filter engagement member is selectively engageable with the body engagement member to cover the filter aperture with the filter.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of an interchangeable filter facemask apparatus according to an embodiment of the disclosure.

FIG. 2 is a side elevation view of an embodiment of the disclosure.

FIG. 3 is an exploded view of an embodiment of the disclosure.

FIG. 4 is a rear elevation view of an embodiment of the disclosure.

FIG. 5 is a side elevation view of an embodiment of the disclosure.

FIG. 6 is a side elevation view of an embodiment of the disclosure.

FIG. 7 is a side elevation view of an embodiment of the disclosure.

FIG. 8 is a cross-sectional view of an embodiment of the disclosure.

FIG. 9 is an in-use view of an embodiment of the disclosure.

### DETAILED DESCRIPTION OF THE INVENTION

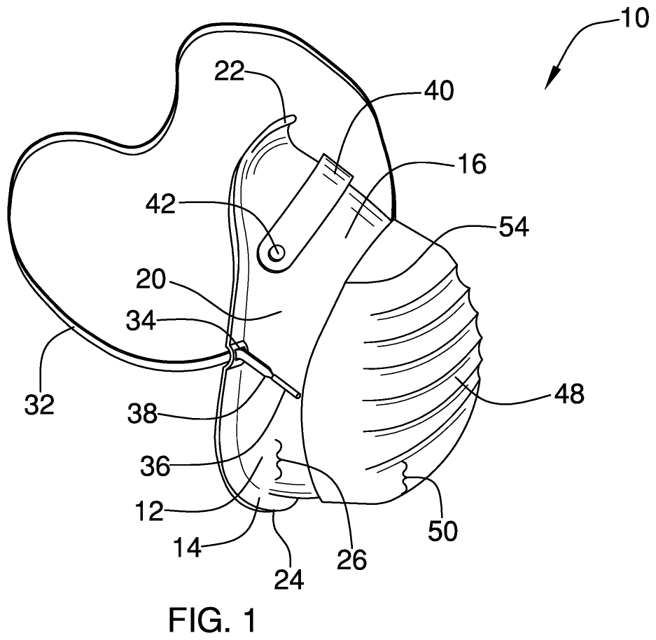

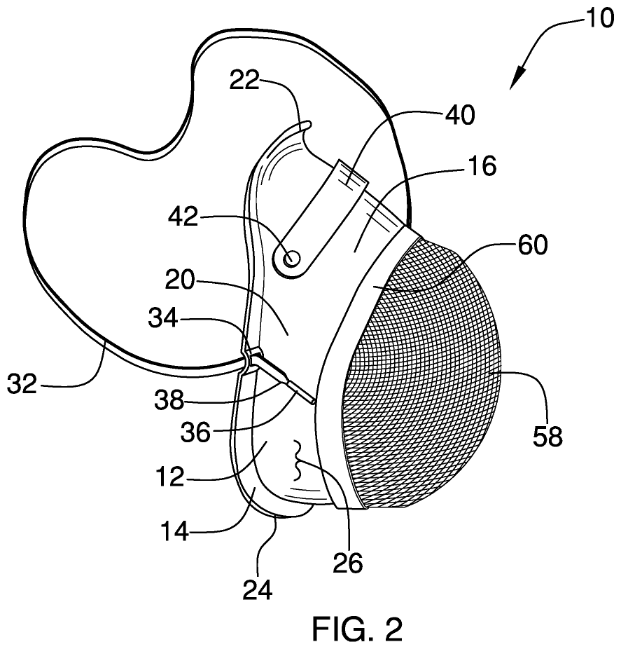

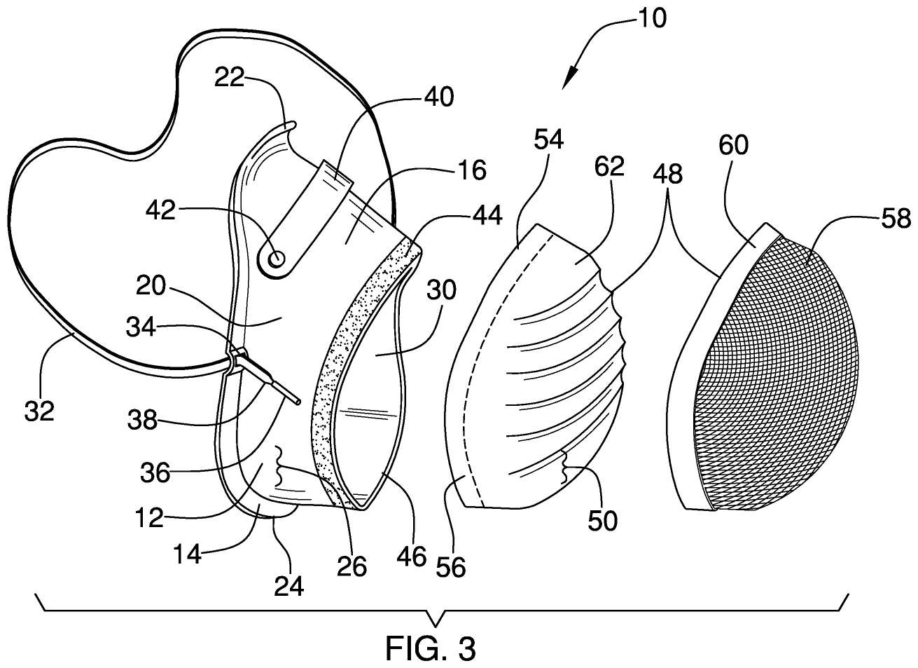

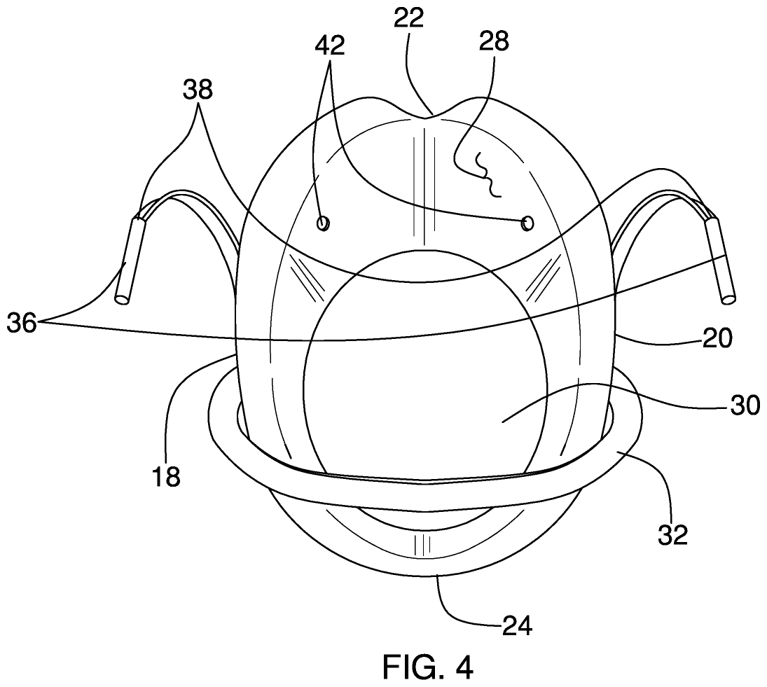

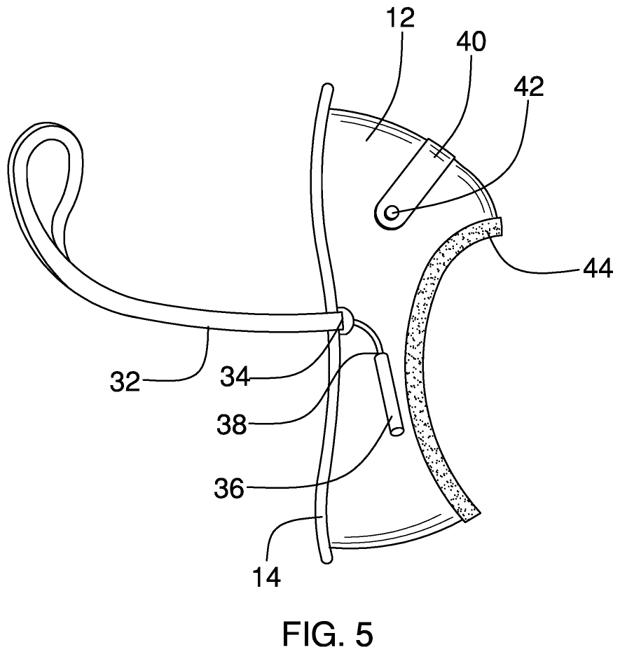

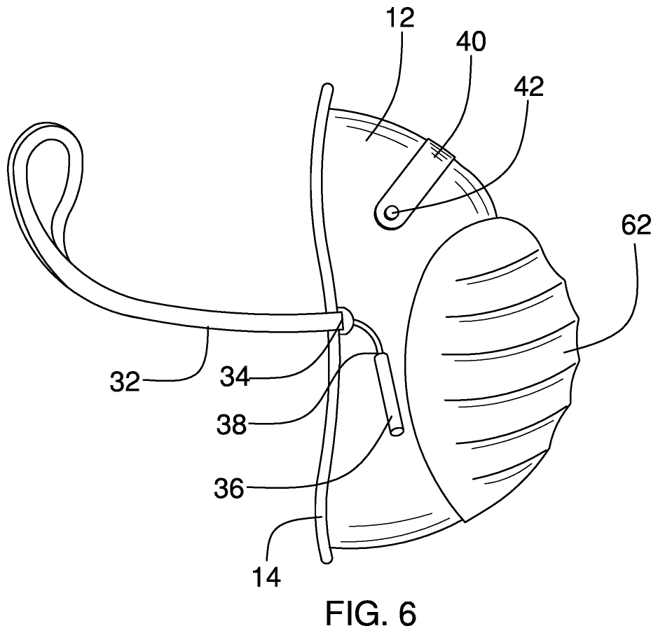

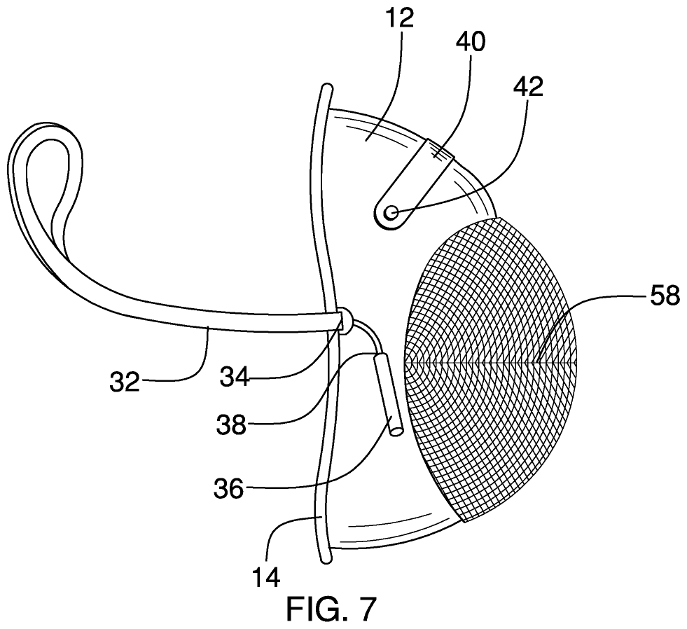

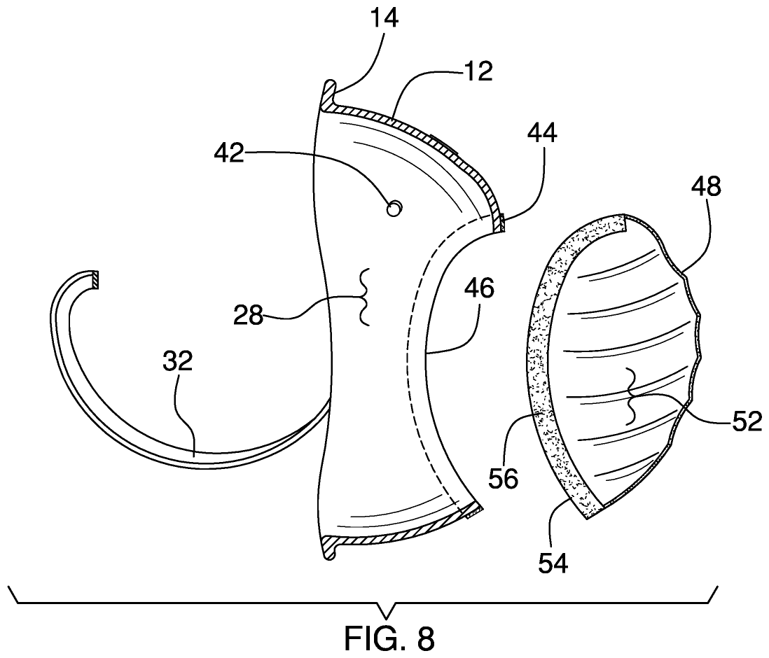

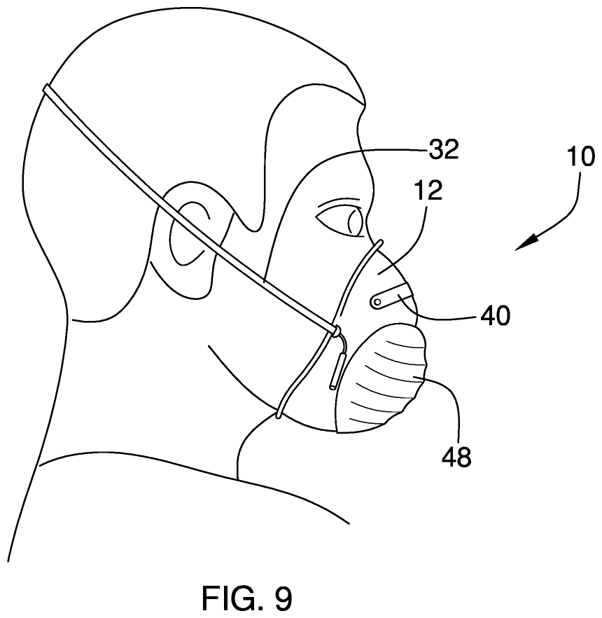

With reference now to the drawings, and in particular to FIGS. 1 through 9 thereof, a new protective breathing device embodying the principles and concepts of an embodiment of the disclosure and generally designated by the reference numeral 10 will be described.

As best illustrated in FIGS. 1 through 9, the interchangeable filter facemask apparatus 10 generally comprises a mask body 12 including a body perimeter portion 14 configured to encompass a user's mouth and nose. The mask body 12 has a sidewall 16 extending from the body perimeter portion 14, a body left side 18, a body right side 20, a body nose side 22, a body chin side 24, a body outside 26, and a body inside 28. The sidewall 16 has a filter aperture 30 extending from the body outside 26 through the body inside 28. The body perimeter portion 14 may be flanged from the sidewall 16 to create a more comfortable fit and stronger seal against the user's face.

A headband 32 is coupled to the mask body 12. The headband 32 is coupled to the body perimeter portion 14 and extends from the body left side 18 to the body right side 20. The headband 32 may be elasticized and may be adjustably engaged through a pair of engagement slots 34 extending through the body perimeter portion 14 of the mask body. Each engagement slot 34 may pinch the headband 32 sufficiently to allow adjustment only when pulled by the user. The headband 32 may have a pair of cylindrical tips 36 coupled to a pair of distal ends 38 to prevent accidental disengagement through the pair of engagement slots 34.

A nose clip 40 may be coupled to the mask body 12. The nose clip 40 is coupled to the body outside 26 proximal the body nose side 22 and extends from the body left side 18 to the body right side 20. The nose clip 40 is sufficiently deformable to secure the mask body 12 to the user's nose when pinched. The nose clip 40 may have a pair of pins 42 extending through to the body inside 28 to secure the nose clip 40 to the mask body 12.

A body engagement member 44 is coupled to the mask body 12. The body engagement member 44 is coupled to the body outside 26 adjacent an aperture perimeter 46 of the filter aperture. The body engagement member 44 may extend continuously around the aperture perimeter 46.

A plurality of filters 48 each has a filter outside 50, a filter inside 52, and a filter perimeter 54. Each filter 48 has a filter engagement member 56 coupled to the filter inside 52 adjacent the filter perimeter 54. The filter engagement member 56 is selectively engageable with the body engagement member 44 to cover the filter aperture 30 with the filter 48. The filter engagement member 56 may extend continuously around the filter perimeter 54. Each of the body engagement member 44 and the filter engagement member 56 may be selectively engageable fasteners such as, but not limited to, hook-and-loop fasteners, reusable adhesives, magnetic strips, and the like. One of the plurality of filters 48 may be a wire mesh screen 58 configured to filter insects. The wire mesh screen 58 has a solid screen perimeter portion 60 adjacent the filter perimeter 54 to receive the filter engagement member 56. One of the plurality of filters 48 may be a solid paper filter 62 configured to filter allergens, dust, and viruses.

In use, the mask body 12 is put in place over the user's mouth and nose and the headband 32 and nose clip 40 are adjusted to create a secure fit. The desired filter 48 is then engaged to cover the filter aperture 30 and is replaced as needed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An interchangeable filter facemask apparatus comprising:
a mask body, the mask body including a body perimeter portion configured to encompass a user's mouth and nose, a sidewall extending from the body perimeter portion, a body left side, a body right side, a body nose side, a body chin side, a body outside, and a body inside, the sidewall having a filter aperture extending from the body outside through the body inside;
a headband coupled to the mask body, the headband being coupled to the body perimeter portion and extending from the body left side to the body right side;
a body engagement member coupled to the mask body, the body engagement member being coupled to the body outside adjacent an aperture perimeter of the filter aperture; and
a plurality of filters, each filter having a filter outside, a filter inside, and a filter perimeter, each filter having a filter engagement member coupled to the filter inside adjacent the filter perimeter, the filter engagement member being selectively engageable with the body engagement member to cover the filter aperture with the filter.

2. The interchangeable filter facemask apparatus of claim 1 further comprising one of the plurality of filters being a wire mesh screen configured to filter insects, the wire mesh screen having a solid screen perimeter portion adjacent the filter perimeter.

3. The interchangeable filter facemask apparatus of claim 1 further comprising one of the plurality of filters being a solid paper filter configured to filter allergens, dust, and viruses.

4. The interchangeable filter facemask apparatus of claim 1 further comprising the headband being adjustably engaged through a pair of engagement slots extending through the body perimeter portion of the mask body.

5. The interchangeable filter facemask apparatus of claim 4 further comprising the headband having a pair of cylindrical tips coupled to a pair of distal ends, the pair of cylindrical tips preventing accidental disengagement through the pair of engagement slots.

6. The interchangeable filter facemask apparatus of claim 1 further comprising a nose clip coupled to the mask body, the nose clip being coupled to the body outside proximal the body nose side and extending from the body left side to the body right side, the nose clip being sufficiently deformable to secure the mask body to the user's nose.

7. The interchangeable filter facemask apparatus of claim 6 further comprising the nose clip having a pair of pins extending through to the body inside.

8. The interchangeable filter facemask apparatus of claim 1 further comprising the body perimeter portion being flanged from the sidewall.

9. An interchangeable filter facemask apparatus comprising:
a mask body, the mask body including a body perimeter portion configured to encompass a user's mouth and nose, a sidewall extending from the body perimeter portion, a body left side, a body right side, a body nose side, a body chin side, a body outside, and a body inside, the sidewall having a filter aperture extending from the body outside through the body inside, the body perimeter portion being flanged from the sidewall;
a headband coupled to the mask body, the headband being coupled to the body perimeter portion and extending from the body left side to the body right side, the headband being adjustably engaged through a pair of engagement slots extending through the body perimeter portion of the mask body, the headband having a pair of cylindrical tips coupled to a pair of distal ends, the pair of cylindrical tips preventing accidental disengagement through the pair of engagement slots;
a nose clip coupled to the mask body, the nose clip being coupled to the body outside proximal the body nose side and extending from the body left side to the body right side, the nose clip being sufficiently deformable to secure the mask body to the user's nose, the nose clip having a pair of pins extending through to the body inside;
a body engagement member coupled to the mask body, the body engagement member being coupled to the body outside adjacent an aperture perimeter of the filter aperture; and
a plurality of filters, each filter having a filter outside, a filter inside, and a filter perimeter, each filter having a filter engagement member coupled to the filter inside adjacent the filter perimeter, the filter engagement member being selectively engageable with the body engagement member to cover the filter aperture with the filter, one of the plurality of filters being a wire mesh screen configured to filter insects, the wire mesh screen having a solid screen perimeter portion adjacent the filter perimeter, one of the plurality of filters being a solid paper filter configured to filter allergens, dust, and viruses.
